(19) United States
(12) Patent Application Publication
(10) Pub. No.: US 2003/0156116 A1
(43) Pub. Date: Aug. 21, 2003

(54) Data processing system and method

(76) Inventor: Olivier Hamon, Crolles (FR)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/345,400

(22) Filed: Jan. 16, 2003

(30) Foreign Application Priority Data
Jan. 18, 2002 (EP) 02354008.1

(51) Int. Cl. G09G 5/00

(52) U.S. Cl. 345/531; 345/212

(57) ABSTRACT

A video display unit of a data processing system having a large number of computers is remotely configurable. To reduce installation and maintenance time and number of skilled personnel, devices of the system that typically have been controlled locally are controlled remotely. A control memory stores plural image parameter data to control image presentation on a display. The memory is externally accessible by a bi-directional data bus for writing image parameter data to and reading image parameter data from the control memory. All monitors are configured and controlled remotely via a suitable server or terminal. The visual display unit is controlled remotely via a systems administrator's server or PC, which removes the need for the technical personnel to attend a client's site. All PCs within a PC park are initialized simultaneously and remotely.

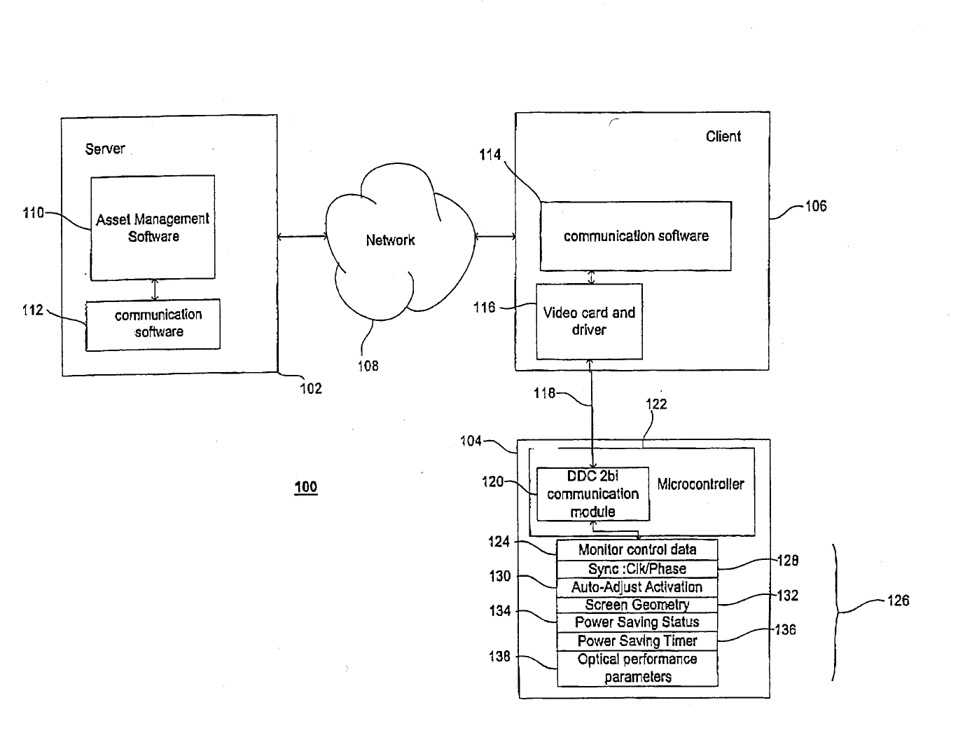

### FIELD OF THE INVENTION

The present invention relates to a data processing system and method and, more particularly, to such a system and method for controlling display devices within a park of computers as well as to a visual display device therefor.

### BACKGROUND OF THE INVENTION

Within large organizations having, for example, a thousand or more employees, it is typical for each employee to have on their desk a personal computer (PC). The computers may be desktop or laptop computers having an associated video display unit (VDU). The display may be either a traditional cathode ray tube display or a liquid crystal display (LCD) as are commonly found on laptop computers and state of the art desktop computers. The user's experience and degree of satisfaction of use of a computer can, in part, be attributed to the quality of the VDU used with that computer. Therefore, information technology (IT) managers and installation personnel are often keen to ensure that the display has been correctly initialized or set-up to provide optimum performance and viewing pleasure for the user. It will be appreciated that in a PC park of a relatively large number of PC's it will either take a significant period of time or a significant number of installation personnel to set up correctly all VDU's within the PC park.

It is an object of the present invention at least to mitigate at least some of the problems of the prior art.

### SUMMARY OF INVENTION

Accordingly, a first aspect of the present invention provides a visual display unit comprising a screen for displaying an image and control memory for storing a plurality of control data to influence at least one characteristic of the operation of the visual display unit wherein the memory is externally accessible using a bi-directional data bus for writing the control data to and reading control data from the control memory.

Preferably, the data processing system for the display device comprises a controller arrangement for writing data to and reading data from the control memory in response to an input command. Still more preferably, the input command originates from a remote terminal at which the effect of issuing and implementing the input command is displayed on a display device of the remote terminal.

The present aforementioned system allows system administrators to configure visual display units remotely without having to attend the site where the display unit to be configured is installed.

A second aspect of the present invention provides a data processing system comprising a remote computer having a controller for issuing control commands and associated control data to a client machine via a communication network. The client machine comprises a visual display unit having a control memory for storing control data to influence at least one characteristic of the operation of the visual display unit. A unit responsive to a control command and associated control data writes the received control data to or reads the control data from the control memory of the visual display unit.

Suitably, the control and configuration of the visual display units are achieved remotely.

Preferably, an embodiment provides a data processing system in which the remote computer comprises an addressing arrangement for directing any issued control commands to at least one of a specific client machine of a plurality of client machines or a specific class of client machines of a plurality of client machines.

Hence, a single command can be issued to all PCs within a PC park, a specific PC within the PC park or, for example, all laptop or desktop PCs within the PC park.

An embodiment provides a data processing system in which the addressing arrangement issues a global command to all or at least a selectable number of a plurality of client machines to control a current power consumption mode of all or of the selectable number of client machines.

A further embodiment provides a data processing system in which the global command is a power saving mode command.

A still further embodiment provides a data processing system in which the power saving mode command is arranged to cause all addressed client machines to enter a prescribed power saving mode of operation.

These embodiments have the advantage that a system administrator can arrange for an asset management tool to issue a global power saving mode command automatically at, for example, nighttime when it is likely that all PCs and their associated displays are switched off.

### BRIEF DESCRIPTION OF THE DRAWING

An embodiment of the present invention will now be described, by way of example only, with reference to the accompanying drawing in which the sole FIGURE is a block diagram of a data processing system comprising a display device in accordance with a first embodiment of the present invention.

### DESCRIPTION OF THE PREFERRED EMBODIMENT

The figure includes a data processing system 100 comprising a server 102 for remotely controlling, via a network 108, a display device 104 of a client machine 106. Preferably, the server comprises asset management software 110 for managing the computing assets of a relatively large PC park (not shown) of which the illustrated client machine 106 and display 104 form a part. The server 102 comprises communication software 112 for managing exchanges of data with the client machine 106 and, ultimately, with the display 104. The client machine 106 also comprises communication software 114 for managing the exchange of data with the server and the exchange of data with the display device 104. As is conventional, the client machine also comprises a video card and an associated software driver 116 for storing image data to be transferred to and displayed on the screen (not shown) of the video display device 104.

Bi-directional data channel 118 transfers data between the video card 116 and a Display Data Channel (DDC) 2bi communication module 120 of a microcontroller 122. The microcontroller 122 co-ordinates the display operations within the display device 104. The microcontroller 122 and, more particularly, the DDC 2bi communication module 120 has access to a memory 124 contained within the display device 104. Stored within the memory 124 are a number of control parameters or control data that set-up and control the operation of the display device 104.

In the embodiment shown, the memory comprises control data 126. The control data 126 includes synchronization data 128 for establishing and/or adjusting the phase of the video scan or refresh rate, an auto-adjust activation parameter 130 which is set to true or false according to whether a user of the remote server 102 requires the screen to be adjusted automatically.

For an LCD monitor, the auto-adjust procedure automatically performs image centering, image sizing, that is, automatic determination of an appropriate clock signal, image focusing, i.e., automatically determining the phase of the image, the contrast and the gamma. The auto-adjust activation parameter, when set to true, initializes the display device to a known condition. Screen geometry data 132 controls the geometry of the image displayed on the screen (not shown) of the display device 104. The screen geometry variables include, for example, size, shape, position, horizontal centering, width, vertical centering, height, tilt, orthogonality, trapeze, pin cushion and degauss.

However, shape, that is, height, tilt, orthogonality, trapeze, pin-cushion and degauss, are typical CRT parameters that, preferably, should not be altered for more than one display at a time. This is because all CRTs are physically different due to both differences between models and due to manufacturing tolerances. Therefore, a single set of these parameters may not be suitable for more than one PC display.

Preferably, data relating to the power saving status 134 is also stored within the control memory 124. The power saving status data 134 provides an indication of the power saving capabilities of the display device and its current mode of operation. Power saving timer data 136 is stored within the memory 124. The power saving timing data 136 determines the period of time after which, without any input device of the client machine 106 being actuated, the display device 104 enters or changes its power saving status. Optical performance parameters 138, including brightness, contrast, and color, may also be adjusted.

Some parameters are adjustable in the sense that they have an associated status. For example, the status may be active or otherwise. Within preferred embodiments, a Display Power Management System (not shown) may indicate the power consumption status to be On, Off or in Stand-by mode. The LCD Auto-set parameter may be activated or deactivated. The On Screen Display (OSD) may be operated in locking or service modes. The Display Power Management System has a timer, which controls the duration of the period of inactivity after which the display is placed in a reduced power consumption mode of operation. This duration can be varied. The OSD may vary its position, language and timeout period.

In practice there are a large number of client machines and associated display devices connected to the network 108. An IT system administrator can manage, from the remote server 102, all of the control data 126 of each of the video displays forming part of the PC park.

It will be appreciated that the present invention removes the need to send technically trained personnel to install recently acquired PC equipment and, in a particular, to configure and optimize the display characteristics of a newly installed display device.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, can be combined in any combination, except combinations where at least some of such features and/or steps are mutually exclusive.

Each feature disclosed in this specification (including any accompanying claims, abstract and drawings), can be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment. The invention extends to any novel one, or any novel combination, of the features disclosed in this specification (including any accompanying claims, abstract and drawings), or to any novel one, or any novel combination, of the steps of any method or process so disclosed.

1. A visual display unit comprising a screen for displaying an image and control memory for storing a plurality of control data to influence at least one characteristic of the operation of the visual display unit; the memory being externally accessible by a bi-directional data bus for writing the control data to and reading control data from the control memory, in which the control data comprises at least data to control a current power saving mode of operation, the current power saving mode of operation being one of a plurality of power saving modes of operation.

2. A visual display unit as claimed in claim 1 in which the bus is a DDC 2bi compliant bus.

3. A visual display unit as claimed in claim 1 in which the control data includes data for influencing at least one of color, color temperature, contrast, brightness, refresh rate, horizontal and vertical synchronization.

4. A visual display unit as claimed in claim 1 further comprising a controller for changing the control data in response to receiving a command via the bus.

5. A data processing system comprising a remote computer having a controller arrangement for issuing control commands and associated control data to a client machine via a communication network; the client machine comprising a visual display unit having a screen for displaying an image and control memory for storing a plurality of control data to influence at least one characteristic of the operation of the visual display unit; the memory being externally accessible by a bi-directional data bus for writing the control data to and reading control data from the control memory and a unit arranged to be responsive to a control command and the associated control data, for writing the received control data to or reading control data from the control memory of the visual display unit.

6. A data processing system as claimed in claim 5 in which the remote computer comprises an addressing arrangement for directing any issued control commands to at least one of a specific client machine of a plurality of client machines or to a specific class of client machines of a plurality of client machines.

7. A data processing system as claimed in claim 5 in which the control data comprises at least data to control a current power saving mode of operation; the current power saving mode of operation being one of a plurality of power saving modes of operation, the addressing arrangement being arranged for issuing a global command to all or at least a selectable number of a plurality of client machines for controlling the current power saving mode of all or the selectable number of the client machines.

8. A data processing system as claimed in claim 7 in which the global command is a power saving mode command.

9. A data processing system as claimed in claim 8, in which the power saving mode command is arranged to cause all addressed client machines to enter a prescribed power saving mode of operation.

10. A data processing system comprising a remote computer having a controller for issuing control commands and associated control data, to a client machine via a communication network, the client machine comprising:
a visual display unit having a screen for displaying an image and control memory for storing control data to control a current power saving mode of operation, the current power saving mode of operation being one of a plurality of power saving modes of operation, the memory being externally accessible by a bi-directional data bus for writing the control data to and reading control data from the control memory; and
a unit arranged to be responsive to receiving a control command and the associated control data, for writing the received control data to or reading control data from the control memory of the visual display unit,
the remote computer comprising:
an addressing arrangement for issuing a power saving mode command to all or at least a selectable number of a plurality of client machines to control the current power saving mode of all or the selectable number of the client machines.

11. A method of operating a data processing system as claimed in claim 10 comprising issuing a power saving mode command to all or at least a selectable number of a plurality of client machines to control the current power saving mode of all or the selectable number of the client machines.
